(19) United States
(12) Patent Application Publication
(10) Pub. No.: US 2019/0172014 A1
(43) Pub. Date: Jun. 6, 2019

(54) AUTOMATIC IDENTIFICATION OF ELECTRONIC MESSAGES FOR SUBSEQUENT MESSAGING ACTIONS

(71) Applicant: Google LLC, Mountain View, CA (US)

(72) Inventors: Timothy Youngjin Sohn, Los Altos, CA (US); Hannah Pauline Keiler, San Francisco, CA (US); Annika Catherine Matta, Sunnyvale, CA (US); Siyu You, Santa Clara, CA (US); Arthur Edward Tilley, III, Berkeley, CA (US); Marek Lipczak, Kitchener (CA); William George Caudwell Pearce, New York, NY (US); Garrick Nadim Toubassi, Los Altos, CA (US); Natasha Sandy, Mountain View, CA (US)

(21) Appl. No.: 15/832,374

(22) Filed: Dec. 5, 2017

(51) Int. Cl. G06Q 10/10; H04L 12/58

(52) U.S. Cl. CPC G06Q 10/107; H04L 51/20; H04L 51/24

(57) ABSTRACT

A system is described including a processor and a model configured to automatically identify electronic messages that are likely to result in the computing system performing one or more subsequent messaging actions. The processor is configured to responsive to determining that an electronic message satisfies initial criteria for invoking the model, determine, using the model, whether the electronic message is likely to result in the system performing a messaging action from the one or more subsequent messaging actions. Responsive to determining that the electronic message is likely to result in the system performing the messaging action, the processor is configured to modify the electronic message to include an indication of the messaging action and a future time for outputting a notification of the messaging action, and output, at the future time, the notification of the messaging action.

### BACKGROUND

Some computing systems provide electronic messaging services that facilitate quick and easy communication between user accounts. For example, e-mail systems are configured to exchange e-mail messages between e-mail accounts of user recipients. Some electronic messages require users to perform subsequent messaging actions, such as replying to an inbound message or following-up on an outbound message. Some user accounts handle a large quantity of electronic messages; the large quantity of electronic messages may cause older electronic messages to be displaced by more recent electronic messages and users may forget to reply, follow-up, or otherwise perform subsequent messaging actions on the displaced, older electronic messages.

### SUMMARY

In general techniques of this disclosure are directed to enabling a computing system to automatically identify and promote electronic messages that likely require a subsequent messaging action to be taken, such as a reply, a follow-up, or other subsequent messaging action. An example computing system receives, either for inbound or outbound processing, a new electronic message, such as an e-mail message. With explicit permission to analyze personal information of the user (e.g., inbound and outbound messages), a model (e.g., a machine-learned model, or other type of model) of the example computing system determines whether the new e-mail message will likely require a subsequent messaging action to be performed by a user sender or recipient and therefore is a “candidate message” suitable for promotion at a later time. For example, the example computing system may determine that an inbound or outbound message that poses a question or otherwise seems to request a reply from a recipient is a candidate message suitable for subsequent promotion. The example computing system modifies metadata of candidate messages to include an indication of the subsequent messaging action to be performed and a future time for notifying a user of the subsequent messaging action. At the notification time indicated by the metadata of a candidate message, if the computing system determines promotion is still necessary, the computing system promotes the candidate message, for instance, by notifying the user that he or she may want to perform a subsequent messaging action on the candidate message. As one example, the computing system promotes inbound and outbound candidate messages by disregarding other rules for organizing messages and instead moving the candidate messages to a most prominent area of an e-mail client user interface (e.g., a top portion of an inbox that orders messages from newest-to-oldest chronological order even though the candidate message is not a newest message). During promotion, the computing system may further indicate in the user interface why the candidate message was promoted or specifically, the subsequent messaging action that the computing system recommends be taken.

In this way, an example computing system (such as an e-mail system or other messaging system) may improve usability of a messaging service by automatically promoting and notifying a user about candidate messages that still likely require their attention, at a time when the user likely needs to follow-up or respond to the message. By automatically moving candidate messages to the forefront of a client user interface, the computing system may focus a user's attention on candidate messages; thereby reducing interaction time between the user and the computing system since the user no longer needs to recall or search for messages that need his or her reply. Such automation may promote more efficient user interactions with the computing system thereby causing the example computing system to receive fewer false inputs or fewer inputs in general than other computing systems that do not identify and promote candidate messages in this way. The example computing system may therefore perform fewer operations and may consume less electrical power and/or result in battery power savings, as compared to other computing systems. In addition, the example computing system may provide a less frustrating more enjoyable user experience.

Throughout the disclosure, examples are described wherein a computing device and/or computing system may analyze information (e.g., e-mail, other communications, and the like) associated with the computing device the user of the computing device only if the computing device and/or the computing system receives explicit permission from the user of the computing device to analyze the information. For example, in situations discussed below in which the computing device and/or computing system may collect or may make use of communication information associated with the user and the computing device, the user may be provided with an opportunity to provide input to control whether programs or features of the computing device and/or computing system can collect and make use of user information (e.g., information about a user's e-mail, a user's social network, social actions or activities, profession, a user's preferences, or a user's past and current location), or to dictate whether and/or how the computing device and/or computing system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and/or computing system.

In one example, a method is described that includes determining, by a computing system, whether a particular electronic message satisfies at least one initial criteria from a plurality of initial criteria for invoking a model configured to automatically identify electronic messages that are likely to result in the computing system performing one or more subsequent messaging actions, wherein the one or more subsequent messaging actions include sending reply messages and sending follow-up messages, and responsive to determining that the particular electronic message satisfies the at least one initial criteria for invoking the model, determining, by the computing system, using the model, whether the particular electronic message is likely to result in the computing system performing a particular messaging action from the one or more subsequent messaging actions. The method further includes responsive to determining that the particular electronic message is likely to result in the computing system performing the particular messaging action: modifying, by the computing system, the particular electronic message to include an indication of the particular messaging action and a future time for outputting a notification of the particular messaging action, and outputting, by the computing system, at the future time, the notification of the particular messaging action.

In another example, a computing system is described that includes a model configured to automatically identify electronic messages that are likely to result in the computing system performing one or more subsequent messaging actions, wherein the one or more subsequent messaging actions include sending reply messages and sending follow-up messages, and at least one processor. The at least one processor is configured to determine whether a particular electronic message satisfies at least one initial criteria from a plurality of initial criteria for invoking the model; responsive to determining that the particular electronic message satisfies the at least one initial criteria for invoking the model, determine, using the model, whether the particular electronic message is likely to result in the computing system performing a particular messaging action from the one or more subsequent messaging actions; and responsive to determining that the particular electronic message is likely to result in the computing system performing the particular messaging action: modify the particular electronic message to include an indication of the particular messaging action and a future time for outputting a notification of the particular messaging action; and output, at the future time, the notification of the particular messaging action.

In another example, a computer-readable storage medium is described that includes instructions, that when executed, cause at least one processor to determine whether a particular electronic message satisfies at least one initial criteria from a plurality of initial criteria for invoking a model configured to automatically identify electronic messages that are likely to result in the computing system performing one or more subsequent messaging actions, wherein the one or more subsequent messaging actions include sending reply messages and sending follow-up messages; responsive to determining that the particular electronic message satisfies the at least one initial criteria for invoking the model, determine, using the model, whether the particular electronic message is likely to result in the computing system performing a particular messaging action from the one or more subsequent messaging actions; and responsive to determining that the particular electronic message is likely to result in the computing system performing the particular messaging action: modify the particular electronic message to include an indication of the particular messaging action and a future time for outputting a notification of the particular messaging action; and output, at the future time, the notification of the particular messaging action.

In another example, a system is described that includes means for determining whether a particular electronic message satisfies at least one initial criteria from a plurality of initial criteria for invoking a model configured to automatically identify electronic messages that are likely to result in the computing system performing one or more subsequent messaging actions, wherein the one or more subsequent messaging actions include sending reply messages and sending follow-up messages, and responsive to determining that the particular electronic message satisfies the at least one initial criteria for invoking the model, means for determining, using the model, whether the particular electronic message is likely to result in the computing system performing a particular messaging action from the one or more subsequent messaging actions. The system further includes means for responsive to determining that the particular electronic message is likely to result in the computing system performing the particular messaging action: means for modifying the particular electronic message to include an indication of the particular messaging action and a future time for outputting a notification of the particular messaging action, and means for outputting, at the future time, the notification of the particular messaging action.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example communication system configured to identify and promote, for subsequent follow-up, electronic communications that likely require a subsequent action, in accordance with one or more aspects of the present disclosure.

FIG. 2 is a block diagram illustrating an example computing system that is configured to identify and promote, for subsequent follow-up, electronic communications that likely require a subsequent action, in accordance with one or more aspects of the present disclosure.

FIG. 3 is a flowchart illustrating example operations performed by an example computing system that is configured to identify and promote, for subsequent follow-up, electronic communications that likely require a subsequent action, in accordance with one or more aspects of the present disclosure

### DETAILED DESCRIPTION

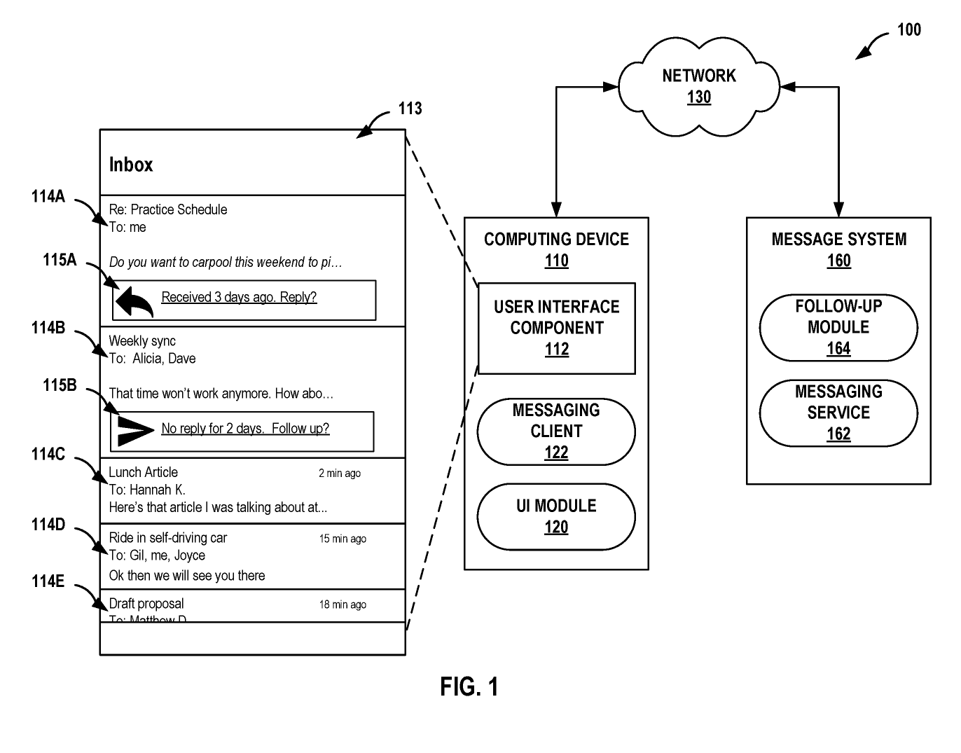

FIG. 1 is a conceptual diagram illustrating an example communication system configured to identify and promote, for subsequent follow-up, electronic communications that likely require a subsequent action, in accordance with one or more aspects of the present disclosure. System 100 of FIG. 1 includes message system 160 in communication, via network 130, with computing device 110. Although system 100 is shown as being distributed amongst digital message system 160 and computing device 110, in other examples, the features and techniques attributed to system 100 may be performed internally, by local components of computing device 110.

Network 130 represents any public or private communications network, for instance, cellular, Wi-Fi, and/or other types of networks, for transmitting data between computing systems, servers, and computing devices. Message system 160 may exchange data, via network 130, with computing device 110 to provide a messaging service that is accessible to computing device 110 when computing device 110 is connected to network 130. Network 130 may include one or more network hubs, network switches, network routers, or any other network equipment, that are operatively inter-coupled thereby providing for the exchange of information between message system 160 and computing device 110. Computing device 110 and message system 160 may transmit and receive data across network 130 using any suitable communication techniques. Computing device 110 and message system 160 may each be operatively coupled to network 130 using respective network links. The links coupling computing device 110 and message system 160 to network 130 may be Ethernet or other types of network connections and such connections may be wireless and/or wired connections.

Message system 160 represents any suitable remote computing system, such as one or more desktop computers, laptop computers, mainframes, servers, cloud computing systems, etc., that is configured to hosting an electronic messaging service. For example, messaging system 160 may be one or more mail servers configured to provide an e-mail messaging service. Computing device 110 represents an individual mobile or non-mobile computing device that is configured to access the messaging service provided by message system 160. Examples of computing device 110 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or security system), a voice-interface or countertop home assistant device, a personal digital assistants (PDA), a gaming system, a media player, an e-book reader, a mobile television platform, an automobile navigation or infotainment system, or any other type of mobile, non-mobile, wearable, and non-wearable computing device configured to access an electronic messaging service.

Message system 160 includes follow-up module 164 and messaging service module 162; computing device 110 includes user interface component (“UIC”) 112, user interface (“UI”) module 120, and messaging client module 122. Modules 120, 122, 162, and 164 may perform operations described herein using software, hardware, firmware, or a mixture of hardware, software, and firmware residing in and/or executing at computing device 110. Computing device 110 and message system 160 may execute modules 120, 122, 162, and 164 with multiple processors or multiple devices, as virtual machines executing on underlying hardware, as one or more services of an operating system or computing platform, and/or as one or more executable programs at an application layer of a computing platform of computing device 110 or message system 160.

UIC 112 of computing device 110 functions as an input and/or output device for computing device 110. UIC 112 may be implemented using various technologies. For instance, UIC 112 may function as an input device using presence-sensitive input screens, microphone technologies, infrared sensor technologies, or other input device technology for use in receiving user input. UIC 112 may function as output device configured to present output to a user using any one or more display devices, speaker technologies, haptic feedback technologies, or other output device technology for use in outputting information to a user. As an input device, UIC 112 detects input (e.g., touch and non-touch input) from a user of computing device 110. Examples of user input gestures performed by a user (e.g., the user touching, pointing, and/or swiping at or near one or more locations of UIC 112 with a finger or a stylus pen). As an output device, UIC 112 presents information (e.g., audible, visual, and/or haptic information) to a user in the form of a user interface (e.g., user interface 113).

UI module 120 of computing device 110 controls UIC 112 including determining what UIC 112 presents and what information is exchanged between UIC 112 and other applications or components of computing device 110. For example, in controlling what UIC 112 displays, UI module 120 may receive information from a component of computing device 110, such as messaging client module 122, for generating user interface 113 and elements thereof. In response, UI module 120 may output instructions and information to UIC 112 that cause UIC 112 to display user interface 113 according to the information received from messaging client module 122. When handling input detected by UIC 112, UI module 120 may receive information from UIC 112 in response to inputs detected at locations of a screen of UIC 112 at which elements of user interface 113 are displayed. UI module 120 disseminates information about inputs detected by UIC 112 to other components of computing device 110 for interpreting the inputs and for causing computing device 110 to perform one or more functions in response to the inputs.

User interface 113 represents a graphical user interface from which a user of computing device 110 can interact with a messaging service accessed by computing device 110, such as the messaging service provided by message system 160. User interface 113 includes a view of an inbox of a messaging service mailbox. Within the inbox, user interface 113 includes graphical indications of electronic messages 114A-114E that are contained in the inbox.

Messaging client module 122 and messaging service module 162 communicate via network 130 to provide a messaging service to computing device 110. Examples of a messaging service include: e-mail service, text messaging service, short message service, simple service messaging, multimedia message service, social media messaging service, voice message service, video message service, or any other service that facilitates the exchange of human-readable electronic messages. As used throughout the disclosure, the term “electronic message” is used to generally describe any type of human-readable electronic message that might be transmitted between computing devices. Examples of electronic messages include: instant messages, chat messages, electronic mail (e-mail) messages, social media communications, voicemail messages, video messages, or any other type of person-to-person communication that is accessed via a computing device.

Messaging client module 122 provides the front-end, user facing features of the messaging service whereas messaging service module 162 supports the back-end operations needed to implement the messaging service on network 130. Messaging client module 122 is a portal from which computing device 110 accesses electronic messages stored at message system 160 and/or at computing device 110. Messaging client module 122 may be an e-mail application, web application, or other module executing at computing device 110 that communicates with message system 160 to provide a user of computing device 110 with access to messages maintained at message system 160 and/or computing device 110.

Messaging service module 162 processes electronic messages received via network 130 from computing device 110 as well as other computing devices and messaging systems that are communicating via network 130. Messaging client module 122 processes inbound electronic messages received via network 130 from message system 160 and sends, via network 130, outbound electronic messages to messaging service module 162 for further processing.

Messaging client module 122 and messaging service module 162 maintain a messaging account associated with a user of computing device 110. That is, messages sent from or received by computing device 110 may be stored in a sent box or an inbox of a messaging account associated with a user of computing device 110. The sent box and inbox may be maintained in memory of computing device 110 and/or message system 160.

In a simple case when handling an inbound message that is destined for computing device 110, messaging service module 162 receives (e.g., via network 130) an electronic message for processing. Messaging service module 162 determines (e.g., from metadata of the electronic message) one or more recipients of the electronic message. If one of the recipients is a messaging account associated with the user of computing device 110, messaging service module 162 may cause a copy of the electronic message to be stored in an inbox of the messaging account associated with the user of computing device 110, whether that messaging account is stored locally at messaging system 160 or computing device 110.

Likewise, when handling an outbound message that originated from computing device 110, messaging service module 162 receives (e.g., via network 130) an electronic message for processing. Messaging service module 162 determines (e.g., from metadata of the electronic message) one or more recipients of the electronic message and sends the message to devices or message systems associated with the one or more recipients. Messaging service module 162 may cause a copy of the electronic message being sent to be stored as a sent item in the messaging account associated with the user of computing device 110, whether that messaging account is stored locally at messaging system 160 or computing device 110.

Follow-up module 164 of message system 160 is configured to automatically identify and promote electronic messages received by messaging service module 162 that likely require a subsequent messaging action to be taken, such as a reply, a follow-up, or other subsequent messaging action. Although shown as part of message system 160, in some examples, some or all of follow-up module 164 executes as part of computing device 110 where follow-up module 164 is configured to automatically identify and promote electronic messages received by messaging client module 122 that likely require a subsequent messaging action to be taken. Said differently, some or all of the operations described herein which are attributed to follow-up module 164 may be performed by message system 160 and/or computing device 110 (e.g., if computing device 110 is offline and disconnected from network 130).

With explicit permission to analyze personal information of a user of the messaging service provided by messaging service module 162 (e.g., inbound and outbound messages), follow-up module 164 determines whether a newly received message will likely require a subsequent messaging action to be performed by a user sender of the newly received message, or a user recipient of the newly received message, and therefore is a “candidate message” suitable for promotion at a later time. For example, after a user consents to message system 160 analyzing his or her electronic messages for potential follow-up, follow-up module 164 may determine that content (e.g., message text, text of other messages in a messaging thread) of an inbound message destined for computing device 110 or an outbound message being sent from computing device 110 poses a question or otherwise seems to request a reply from a recipient. In response to determining that the electronic message poses a question or otherwise seems to request a reply from a recipient, follow-up module 164 determines that the electronic message is a candidate message suitable for subsequent promotion.

Follow-up module 164 uses a machine learning model to identify and modify candidate messages that are suitable for subsequent promotion. The machine learning model may modify one or more fields of metadata of a candidate message to include an indication (e.g., data) of the subsequent messaging action to be performed and a future time for notifying a user of the subsequent messaging action. To save power, improve system speed, or otherwise avoid having to run a complex machine learning model on every electronic message that is received by message system 160, follow-up module 164 may use initial criteria to filter out promotional messages, spam messages, junk messages, already deleted messages, or other messages that are likely unsuitable for subsequent promotion anyway, before invoking its machine learning model. That is, follow-up module 164 may use initial criteria to determine if a message is a personal (e.g., person-to-person) message that might include content in need of a reply, follow-up, or other subsequent messaging action. If a message satisfies the initial criteria, follow-up module 164 may invoke its machine learning model to identify and modify candidate messages that are suitable for subsequent promotion.

Various examples of initial criteria exist. In some instances, the initial criteria used by follow-up module 164 includes textual content that is indicative of a request directed specifically to at least one recipient of the particular electronic message (e.g., a question posed to a person, a statement directed at a person, a question mark), or other request. For example, as shown in FIG. 1, electronic message 114A includes text of a question “Do you want to carpool this weekend to . . . ” which is addressed to a user recipient. By including a question posed to a recipient, follow-up module 164 may determine that electronic message 114A satisfies the initial criteria for further evaluation. In some cases, the initial criteria used by follow-up module 164 may include textual content that indicates some action is still needed (e.g., a request for a reply, a request for a draft, a request for a phone call, a promise to respond, an acknowledgment that a response will be forthcoming, or other acknowledgement or request). As shown in FIG. 1, electronic message 114B includes text “That time won't work anymore. How about . . . ” By including a request for input from a user recipient, follow-up module 164 may determine that electronic message 114B satisfies the initial criteria for further evaluation. The initial criteria may include textual content that is indicative a specific date, time, or deadline (e.g., a due date, a RSVP, or other deadline). The initial criteria may be addressee based (e.g., sender or recipient). That is, follow-up module 164 may use initial criteria to determine whether a sender of a message or at least one recipient of the message is associated with a message account of a user (e.g., a person) that is likely to respond to the particular electronic message or receive a reply to the particular electronic message. For example, if the only recipient of a message is associated with a group mailbox, then the initial criteria might filter out the message whereas if a recipient is a message account associated with a sender's contact list, then the initial criteria may pass the message on for further processing to determine whether it's a candidate message suitable for subsequent messaging actions.

The model of follow-up module 164 is trained to automatically identify and modify for subsequent promotion, electronic messages that are likely require a subsequent messaging action to be taken. The model's training comes from observations of past user behavior with regard to the messaging service provided by message system 160 and accessed by computing device 110. For instance, the model may be a neural network, a long-short-term memory model, or other machine-learned model that is configured to determine from several signals associated with a message, a subsequent action to be taken on the message, and a future time for performing the subsequent action. The model receives, as input, content from electronic messages (e.g., message text, message images, message videos, etc.) and metadata from the electronic messages (e., information indicating the message's sender(s), recipient(s), date and time at which the message was sent and received, and other metadata). The model produces, as output, modified electronic messages that include fields of metadata indicating what subsequent actions are likely needed to be taken as well as future times for notifying users of the subsequent actions.

With explicit permission previously obtained from users to make use of and analyze their electronic messaging behavior, the training corpus of message behaviors used to train the model of follow-up module 164 may include messaging behavior associated with a user of computing device 110 with regard to messaging client module 122 and/or messaging behavior of other users of the messaging system provided by message system 160. Message system 160 and computing device 110 further provides a way for users to withdraw consent to make use of and analyze their electronic messaging behavior and in response, message system 160 and computing device 110 stop analyzing the message behavior of those that withdraw consent.

Follow-up module 164 modifies candidate messages on behalf of a user of computing device 110, prior to the candidate messages being stored locally at either message system 160 or computing device 110. For instance, an outbound message being sent from computing device 110 may be modified by follow-up modules 164 before a copy of the outbound message is stored as a sent message at a mailbox of the user sender. Whereas, with an inbound message received by computing device 110 may be modified by follow-up modules 164 before a copy of the inbound message is stored as a new message at a mailbox of the user sender. Follow-up module 164 may modify outbound candidate messages on behalf of the user of computing device 110 when he or she is a user sender and may modify inbound candidate messages on behalf of the user of computing device 110 when he or she is a user recipient, however follow-up module 164 may refrain from modifying candidate messages that are stored in message mailboxes of other users.

Messaging service module 162 and messaging client module 122 are configured to automatically promote or surface, a message that has metadata which indicates that the message has been modified by follow-up module 164, at the future time indicated by the metadata. For instance, at a notification time indicated by metadata of a candidate message, messaging client module 122 promotes the candidate message, for instance, by notifying the user that he or she may want to perform a subsequent messaging action on the candidate message.

For example, as shown in FIG. 1, messaging client module 122 sends information to UI module 120 that causes electronic messages 114A and 114B to be promoted by being displayed by UIC 112 in a prominent area (e.g., near the top or prioritized ahead of more recently received messages) of user interface 113. That is, message client module 122 may disregard other rules for ordering or displaying electronic messages and instead, cause UIC 112 to display, in a messaging user interface, a graphical indication of a modified message more prominently than all other indications of electronic messages by displaying the indication of an outbound message (e.g., sent message) 114B including the indication of the recommended subsequent messaging action 115B in a region of the messaging user interface at which a most recently received inbound electronic message was last displayed. Likewise, UIC 112 may display, in a messaging user interface, a graphical indication of a modified message more prominently than all other indications of electronic messages by displaying the indication of an inbound message (e.g., received message) 114A including the indication of the recommended subsequent messaging action 115A in a most recent position of a chronological order of all inbound messages.

Other examples of how messaging client module 122 causes a candidate message to be displayed more prominently exist. For instance, messaging client module 122 may cause a candidate message to be displayed more prominently by causing a graphical indication of the candidate message to have: different character sizes than graphical indications of other messages, different fronts than graphical indications of other messages, different font weights (e.g., bold text) than graphical indications of other messages, different colors than graphical indications of other messages, and/or other visual elements that highlight the message as being different than graphical indications of other messages.

During promotion, messaging client module 122 may cause UI module 120 to indicate in user interface 113 why the candidate message was promoted or specifically, the subsequent messaging action that the computing system recommends be taken. Messaging client module 122 may cause UI module 120 to include, within the graphical indication of a promoted message, an indication of the subsequent action. For example, messaging client might send UI module 120 instructions for including graphical element 115A within the indication of electronic message 114A and graphical element 115B within the graphical indication of electronic message 114B. Each of graphical elements 115A and 115B represents a UI element that, when selected via user input, causes UI module 120 and messaging client module 122 to reconfigure user interface 113 to facilitate the user in performing the subsequent messaging action.

In this way, an example computing system may improve usability of a messaging service by automatically promoting and notifying a user about candidate messages that still likely require their attention, at a time when the user likely needs to follow-up or respond to the message. By automatically moving candidate messages to the forefront of a client user interface, such as user interface 113, an example computing system may cause a user to focus his or her attention on candidate messages; thereby reducing interaction time between the user and the computing system since the user no longer needs to recall or search for messages that need his or her attention. Such automation may promote more efficient user interactions with the example computing system thereby causing the example computing system to receive fewer false inputs or fewer inputs in general than other computing systems that do not identify and promote candidate messages in this way. The example computing system may therefore perform fewer operations and may consume less electrical power and/or result in battery power savings, as compared to other computing systems. In addition, the example computing system may provide a less frustrating more enjoyable user experience.

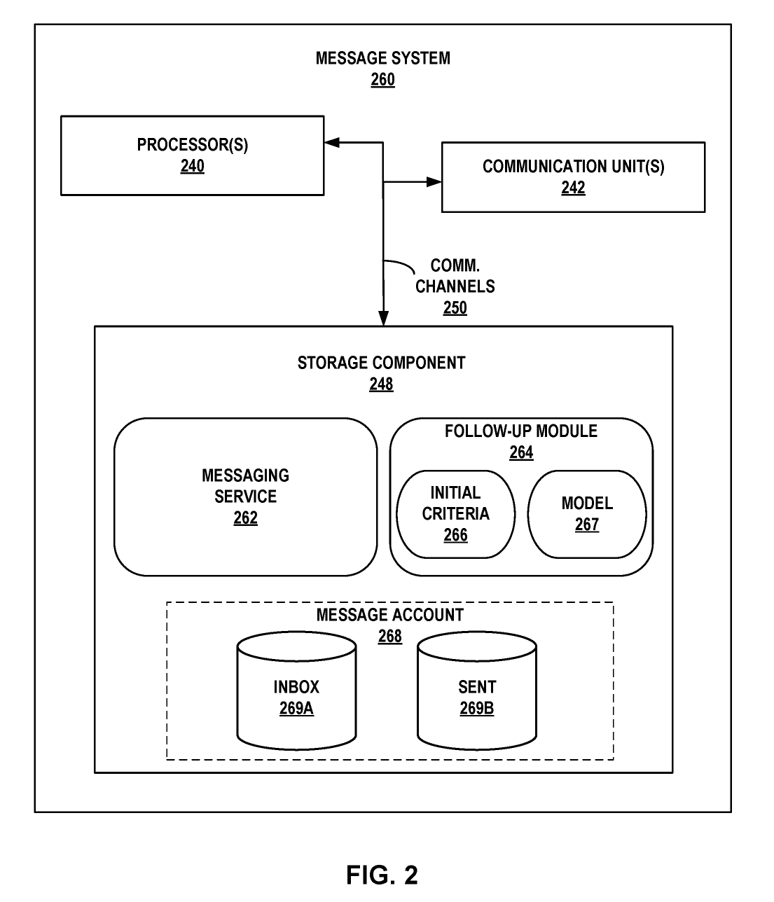

FIG. 2 is a block diagram illustrating an example computing system that is configured to identify and promote, for subsequent follow-up, electronic communications that likely require a subsequent action, in accordance with one or more aspects of the present disclosure. Message system 260 of FIG. 2 is described below as an example of message system 160 of FIG. 1. FIG. 2 illustrates only one particular example of message system 260, and many other examples of message system 260 may be used in other instances and may include a subset of the components included in message system 260 or may include additional components not shown in FIG. 2.

As shown in the example of FIG. 2, message system 260 include one or more processors 240, one or more communication units 242, and one or more storage components 248. Storage components 248 of message system 260 includes messaging service module 262, follow-up module 264, and message account 268 which includes inbox 269A and sent box 269B. Follow-up module 264 includes initial criteria 266 and machine-learning (ML) model 267.

Communication channels 250 interconnect each of the components 240, 242, and 248 for inter-component communications (physically, communicatively, and/or operatively). In some examples, communication channels 250 may include a system bus, a network connection, an inter-process communication data structure, or any other method for communicating data.

One or more communication units 242 communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more storage components 248 store information for processing during operation of message system 260. In some examples, storage component 248 is a temporary memory, meaning that a primary purpose of storage component 248 is not long-term storage. Storage components 248 on message system 260 may be configured for short-term storage of information as volatile memory and therefore not retain stored contents if powered off. Examples of volatile memories include random access memories (RAM), dynamic random-access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with message account 268, modules 262 and 264, initial criteria 266, and ML model 267. Storage components 248 may include a memory configured to store data or other information associated with message account 268, modules 262 and 264, initial criteria 266, and ML model 267.

One or more processors 240 may implement functionality and/or execute instructions associated with message system 260. Examples of processors 240 include application processors, display controllers, auxiliary processors, one or more sensor hubs, and any other hardware configure to function as a processor, a processing unit, or a processing device. Message account 268, modules 262 and 264, initial criteria 266, and ML model 267 may include instructions that are operable by processors 240 to perform various actions, operations, or functions of message system 260. For example, processors 240 may retrieve and execute instructions stored by storage components 248 that cause processors 240 to perform the operations described herein that are attributed to message account 268, modules 262 and 264, initial criteria 266, and ML model 267. The instructions, when executed by processors 240, may cause message system 260 to store information within storage components 248, for example, at message account 268.

Messaging service module 262 may include all functionality of messaging service module 162 of FIG. 1 and may perform similar operations as messaging service module 162 so as to configure message system 260 to provide a network based messaging service. Messaging service module 262 processes electronic messages received via a network, such as network 130. Messaging service module 262 maintains message account 268 which is associated with a user of computing device 110. Messages received by messaging service module 262 that are addressed to message account 268 are stored in inbox 269A of message account 268. Whereas messages received by messaging service module 262 that are sent from message account 268 are stored in sent box 269B. Copies of message account 268 may be replicated and stored locally at other computing devices, such as computing device 110. That is, for any action that messaging service module 262 performs on message account 268, messaging service module 262 may cause a client (such as messaging client module 122) to perform a similar action to a copy of messaging account 268 that stored elsewhere, and remote from message system 260.

Follow-up module 264 may include all functionality of follow-up module 164 of FIG. 1 and may perform similar operations as follow-up module 164. Follow-up module 264 automatically identifies candidate electronic messages that likely require a subsequent messaging action to be taken and modifies the candidate electronic messages to facilitate subsequent promotion. Although shown and described as being part of a message system 260 which is a remote messaging system, some or all of follow-up module 264 may reside locally at, and be executable from, a computing device, such as computing device 110 of FIG. 1.

Follow-up module 264 uses initial criteria 266 to filter out electronic messages that are not likely to require a subsequent messaging action. For example, initial criteria 266 is a set of rules or filters that receive electronic messages as input and outputs an indication of whether an inputted message is worth inputting into a model for determining whether the message requires a subsequent messaging action. Initial criteria 266 may cause only electronic messages that are sent from individual messaging accounts, as opposed to group messaging accounts, marketing messaging accounts, or other non-personal accounts, to be analyzed by follow-up module 264. Examples of initial criteria 266 may include one or more of: a requirement that text associated with a particular electronic message be indicative of a request directed specifically to at least one recipient of the particular electronic message, a requirement that the text associated with the particular electronic message is indicative a specific deadline, a requirement that a sender of the particular electronic message or the at least one recipient of the particular electronic message is a message account of a user that is likely to respond to the particular electronic message or receive a reply to the particular electronic message, and a requirement that the text associated with the particular electronic message is indicative that some action is still needed. Initial criteria 266 may include other requirements not disclosed above.

For electronic messages that pass initial criteria 266, follow-up module 264 uses ML model 267 to identify actionable messages; that is, actual electronic messages that likely require subsequent action. A message is actionable if ML model 267 classifies the message as needing a user action. ML module 267 is configured to modify the electronic messages that it identifies as candidate messages that likely requiring subsequent action so that a messaging client, such as messaging client module 122, will promote the candidate message and the subsequent action, at an appropriate time.

For example, ML model 267 may be a machine-learned model (e.g., a neural network, a long-short-term memory model, or any other type of model). ML model 267 may develop rules or otherwise learn what type of messaging content or metadata is associated with electronic messages for message account 238 that end up requiring a subsequent messaging action. ML model 267 may be trained based on past user actions performed on other electronic messages by users of the messaging service provided by messaging service module 262.

As one example, ML model 267 may determine, based on observing prior messaging behavior of the messaging service provided by messaging service module 262, that whenever an outbound message includes a question as well as a date or time in a subject or body of an electronic message, a follow-up message or a reminder message for a recipient of the outbound message is often sent, particularly if a reply is not received prior to a date or time indicated in the sent message. As another example, ML model 267 may determine, based on observing prior messaging behavior of the messaging service provided by messaging service module 262, that whenever an inbound message includes a particular word or phrase (such as “draft”, “remember”, “reminder” or the like), a reply message addressed to the sender of the inbound message is normally sent. ML model 267 may create a rule that causes any outbound message with a question

ML model 267 may develop rules based on non-textual information derived from message metadata. For instance, ML model 267 may analyze an order of message recipients to determine whether a message requires a subsequent action for a user of message account 238. ML model 267 may observe that when a recipient is listed first in order, any subsequent actions are likely to be the responsibility of the first listed recipient as opposed to a second or third listed recipient. Hence, if ML model 267 receives an electronic message where a user of message account 268 is listed as one of the last recipients, a rule of ML model 267 may cause ML model 267 to determine that the message is not a candidate message for subsequent action. Whereas, if ML model 267 receives an electronic message where a user of message account 268 is listed as one of first last recipients, a rule of ML model 267 may cause ML model 267 to determine that any subsequent action inferred from the message is likely directed to the user and not a different recipient user.

In addition to identifying messages that are likely to require a subsequent messaging action, ML model 267 may also determine what particular messaging action is required as well as a future time that the messaging action needs to be taken or at least a future time that a user should be notified of the messaging action. For example, ML model 267 may infer, from text of an electronic message or text of other messages in a messaging thread that includes the electronic message, whether a candidate message requires a reply or a follow-up, depending on whether a user was a user sender or recipient user of the candidate message. If a user is a user sender, the subsequent messaging action might be sending a follow-up message whereas if the user is a recipient user, the subsequent messaging action might be sending a reply.

In any case, ML model 267 may modify a message to indicate that the message requires a subsequent action by editing one or more fields of metadata of the message to include the indication of the particular messaging action and the future time for outputting the notification of the particular messaging action. For instance, a copy of an outbound message stored in sent box 269B that requires follow-up may include in its metadata, data that indicates to messaging service module 262 and/or messaging client module 162, that the outbound message requires a follow-up and an approximate time for the follow-up. A copy of an inbound message stored in inbox 269A that requires a reply may include in its metadata, data that indicates to messaging service module 262 and/or messaging client module 162, that the inbound message requires a reply and an approximate time for the reply.

In some cases, ML model 267 may determine a future “time” for a follow-up or a reply as being a future context. ML model 267 may modify an inbound or outbound message to include an indication of a future user context (e.g., user location, time of day, date, user activity, etc.) for notifying the user of the follow-up or reply. For example, ML model 267 may determine that, based on observed user behavior, a user of message account 238 almost never replies to old messages at the end of a work day or if the user is at home, but instead, typically catches up on messages in the morning of the subsequent business day when he or she is in the office. ML model 267 may modify metadata of work-related messages that require subsequent message actions to include information that causes notifications of the subsequent actions to be output in the morning, during weekdays, when a user location is in the office.

This way, in the morning, as a user of message account 238 is reviewing new work-related messages via user interface 113 of computing device 110, messaging client module 122 will refrain from moving messages that require subsequent follow-up to the forefront of user interface 113 when the user is still at home (e.g., while eating breakfast). However, when the user is reviewing his or her messages via user interface 113 of computing device 110 after arriving at work in the morning, messaging client module 122 will move messages that require subsequent follow-up to the forefront of user interface 113.

Similar to time and/or location, ML model 267 may modify metadata of a message to indicate other contextual information that need be satisfied before promoting the message. For example, ML model 267 may specify a user activity (e.g., walking, sitting, driving, not driving, listening to music, watching video, interacting with a particular application, eating, sleeping, not eating, not sleeping, etc.) that a user need be performing before promoting a message.

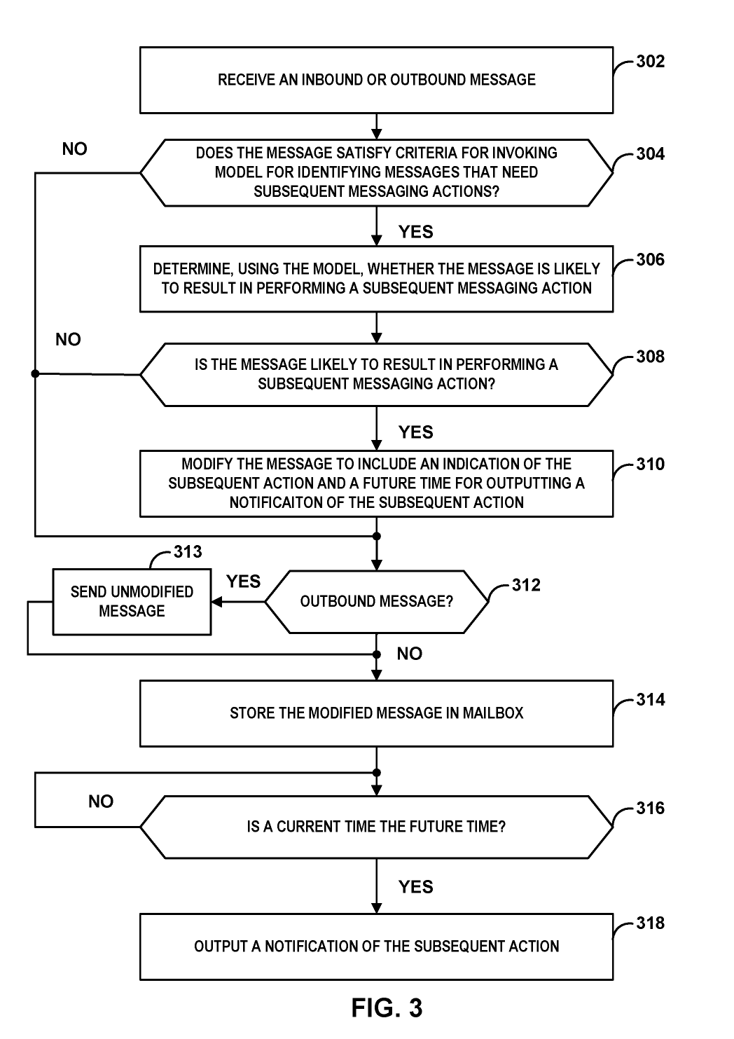

FIG. 3 is a flowchart illustrating example operations performed by an example computing system that is configured to identify and promote, for subsequent follow-up, electronic communications that likely require a subsequent action, in accordance with one or more aspects of the present disclosure. FIG. 3 is described below in the context of message system 260 of FIG. 2.

In accordance with techniques of this disclosure, message system 260 may receive an inbound or outbound message (302). For example, messaging service module 262 may receive, from messaging client module 122, an indication of a new outbound message created by a user of message account 238 or a new inbound message addressed to message account 238.

Message system 260 may determine whether the inbound or outbound message satisfies criteria used for invoking a machine-learning model for identifying messages that need subsequent messaging actions (304). For example, before messaging service module 262 stores an indication of the new message in inbox 269A or sent box 269B, follow-up module 264 may determine whether to modify the message for subsequent action. Follow-up module 264 may evaluate characteristics of the message against initial criteria 266 to determine whether the new message should be considered.

If the message satisfies initial criteria 266 (304, NO Branch), follow-up module 264 will take no action on the message and permit messaging service module 262 to output and or store the message in the appropriate inbox 269A or sent box 269B of message account 238 (see steps 312-314). If however, the message satisfies initial criteria 266 (304, YES Branch), message system 260 may determine, using the machine-learning model, whether the message is likely to result in performing a subsequent messaging action (306). For example, follow-up module 264 may determine, using initial criteria 266, that an outbound message with a question contained in the body of the message satisfies initial criteria 266 needed to invoke ML model 267 whereas an inbound message that includes a question but is from a group messaging account, what appears to be a machine-generated messaging account, or where a user is one of many recipients, does not satisfy initial criteria 266 needed to invoke ML model 267.

Message system 260 may determine, using the machine-learning model, whether the message is likely to result in performing a subsequent messaging action (306). For example, after satisfying initial criteria 266, ML model 267 may analyze characteristics of an inbound or outbound message to determine whether the message is likely to result in performing a subsequent messaging action, and if so, what the subsequent messaging action is, as well as when to notify a user of the subsequent messaging action. For example, ML model 267 may determine that, even though an inbound message with a question contained in the body of the message satisfies initial criteria 266 needed to invoke ML model 267, because the user of message account 238 is a last named recipient of the inbound message or because the question is directed to a user recipient other than the user of message account 238, that the inbound message is not likely to result in performing a subsequent action (308, NO branch). However, ML model 267 may determine that when the user of message account 238 is listed as a first or second named recipient or because the question in the inbound message is directed to a user recipient of message account 238, that the inbound message is likely to result in the user recipient replying to the inbound message (308, YES branch).

Message system 260 may modify the message to include an indication of the subsequent action and a future time for outputting a notification of the subsequent action (310). For example, ML model 267 may modify one or more fields metadata of a message to include an indication that a subsequent reply or subsequent follow-up is likely required.

If no deadline for a reply or follow-up is indicated in a message itself, ML model 267 may infer a deadline or future time for notifying the user as to their likely obligation to reply or follow-up. For example, ML model 267 may specify a future time that coincides with the user's past behavior for performing similar subsequent actions. ML model 267 may select Monday morning as a future time to remind a user to reply to a message received on Friday, since, given a past behavior, ML model 267 has learned that the user almost never replies to messages received on Friday, until after the weekend. ML model 267 may select Wednesday afternoon as a future time to remind a user to follow-up to a message sent Monday morning, since, given a past behavior, ML model 267 has learned that the user almost always gives recipients two days to respond.

If a deadline is specified or eluded to in the original message, ML model 267 may modify the metadata to include an indication of the deadline so that a reminder or notification of the subsequent reply or follow-up is triggered before the deadline occurs. For example, if ML model 267 determines a deadline for the reply that is likely to occur before Monday morning, ML model 267 may modify the metadata to indicate that the reply needs to be sent before the user goes home from work that day, even though the past user behavior dictates that the reply would be unusual for that user.

Message system 260 may determine whether the message is an outbound message (312). If the message is outbound, messaging system processes the original message by sending a copy of the original message, without the modified metadata (313) to a recipient computing system or device. In other words, when processing an outbound message, messaging service module 262 may, modify the outbound message to include an indication of a particular messaging action and a future time for outputting a notification of the particular messaging action, and send the outbound message for delivery to an electronic mailbox of a user recipient of the outbound message

Message system 260 may store the modified message in a mailbox (314). For example, messaging service module 262 may deliver a copy of a modified inbound message to an electronic mailbox of a sender of the electronic message (e.g., sent box 269B) or deliver a copy of a modified outbound message to an electronic mailbox of a recipient of the electronic message (e.g., inbox 269A). By storing the modified message in message account 238, any client in communication with messaging service module 262 can rely on the modified metadata to trigger a notification of the subsequent messaging action.

Message system 260 may determine whether a current time is a future time indicated in a modified message (316). In cases where the current time is the future time (316, YES branch), message system 260 may output a notification of the subsequent action (318). For example, messaging service module 262 may at times check the future time indicated by the metadata of modified messages against a current time. Whenever a future time indicated in modified metadata of a message corresponds to a current time, messaging service module 262 may cause a client, such as messaging client module 122 of computing device 110 to notify a user of a recommended subsequent messaging action indicated by the modified metadata. For example, messaging service module 262 may send an instruction or command to messaging client module 122 that causes messaging client module 122 to notify the user of computing device as to the recommended subsequent messaging action.

In some examples, messaging client module 122 will at times check the future time indicated by the metadata of modified messages against a current time. And whenever a future time indicated in modified metadata of a message corresponds to a current time, messaging client module 122 may notify a user of a recommended subsequent messaging action indicated by the modified metadata without having first received instructions from messaging service module 262.

In some examples, outputting a notification of a messaging action at a future time includes presenting an indication the particular electronic message including an indication of the messaging action. For example, at the future time, or prior to the future time, messaging client module 122 may cause UI module 120 and UIC 122 to display a notification banner or pop-up that includes a graphical indication of the messaging action.

In some examples, messaging client module 122 or messaging service module 262 will move a graphical indication of a message that has an upcoming recommended messaging action to the forefront of a messaging user interface so that a user interacting with the messaging user interface can quickly and easily see the graphical indication of the message along with information about what the recommended messaging action is. For instance, as shown in FIG. 1, at a future time indicated by modified metadata of a particular message, messaging client module 122 may cause UI module 120 and UIC 122 to display, in user interface 113, more prominently than all other indications of electronic messages 114C-114E, an indication of a message 114A or 114B that includes an indication of a messaging action 115A or 115B. In other words, messaging client module 122 may cause a graphical indication of a modified message 114A or 114B (regardless as to whether an inbound or outbound message) to appear at the forefront of user interface 113, that is, at the top of the inbox shown in user interface 113. In addition to displaying the graphical indication of the message 114A or 114B, UIC 122 may display a graphical indication of the subsequent messaging action, such as graphical elements 115A and 115B.

In some examples, not only will messaging client module 122 and messaging service module 262 at times check the future time indicated by the metadata of modified messages against a current time, but the model of follow-up module 164 will evaluate whether a modified message still requires the subsequent action. For instance, if a user deleted an inbound message, such as message 114A, follow-up module 164 may remove the modification to the metadata of message 114A since by deleting message 114A, the user is implicitly indicating he or she does not plan to perform the subsequent reply action. If a user already send a follow-up message regarding an outbound message, such as message 114B, follow-up module 164 may remove the modification to the metadata of message 114B since by already sending a follow-up message to message 114B, the user is implicitly indicating he or she does not plan to perform the subsequent follow-up action again. In short, messaging client module 122 and messaging service module 262 may refrain from outputting the notification of a messaging action in response to determining that the electronic message associated with the messaging action was deleted before the future time associated with the messaging action or that the messaging action was already performed.

Clause 1. A method comprising: determining, by a computing system, whether a particular electronic message satisfies at least one initial criteria from a plurality of initial criteria for invoking a model configured to automatically identify electronic messages that are likely to result in the computing system performing one or more subsequent messaging actions, wherein the one or more subsequent messaging actions include sending reply messages and sending follow-up messages; responsive to determining that the particular electronic message satisfies the at least one initial criteria for invoking the model, determining, by the computing system, using the model, whether the particular electronic message is likely to result in the computing system performing a particular messaging action from the one or more subsequent messaging actions; and responsive to determining that the particular electronic message is likely to result in the computing system performing the particular messaging action: modifying, by the computing system, the particular electronic message to include an indication of the particular messaging action and a future time for outputting a notification of the particular messaging action; and outputting, by the computing system, at the future time, the notification of the particular messaging action.

Clause 2. The method of clause 1, wherein the particular electronic message is an outbound message, the method further comprising: after modifying the outbound message to include the indication of the particular messaging action and the future time for outputting the notification of the particular messaging action, delivering, by the computing system, the outbound message to an electronic mailbox of a user recipient of the outbound message.

Clause 3. The method of clause 1 or clause 2, wherein the particular electronic message is an inbound message, the method further comprising: receiving, by the computing system, the inbound message for delivery to an electronic mailbox of a user recipient of the inbound message; after receiving the inbound message for delivery to one or more recipients of the outbound message, modifying the inbound message to include the indication of the particular messaging action and the future time for outputting the notification of the particular messaging action; and delivering, the inbound message to an electronic mailbox of a user recipient of the inbound message.

Clause 4. The method of any one of clauses 1-3, further comprising: after modifying the particular electronic message to include the indication of the particular messaging action and the future time for outputting the notification of the particular messaging action, storing, by the computing system, in an electronic mailbox of a sender of the electronic message or a recipient of the electronic message, a copy of the particular electronic message that includes the indication of the particular messaging action and the future time for outputting the notification of the particular messaging action.

Clause 5. The method of any one of clauses 1-4, wherein outputting the notification of the particular messaging action at the future time comprises presenting, by the computing system, an indication the particular electronic message including an indication of the particular messaging action.

Clause 6. The method of any one of clauses 1-5, further comprising: outputting, by the computing system, for display, a graphical user interface for managing electronic messages, wherein outputting the notification of the particular messaging action at the future time comprises displaying, more prominently than all other indications of electronic messages, an indication of the particular electronic message including an indication of the particular messaging action.

Clause 7. The method of clause 6, wherein: the particular electronic message is an outbound message, the graphical user interface is configured to display a most recently received inbound electronic message in a particular region of the graphical user interface, and displaying the indication of the outbound message including the indication of the particular messaging action more prominently than all other indications of electronic messages comprises displaying the indication of the outbound message including the indication of the particular messaging action in the region of the graphical user interface at which the most recently received inbound electronic message was last displayed.

Clause 8. The method of clause 6 or 7, wherein: the particular electronic message is an inbound message, the graphical user interface is configured to display all inbound messages in chronological order, and displaying the indication of the inbound message including the indication of the particular messaging action more prominently than all other indications of electronic messages comprises displaying the indication of the inbound message including the indication of the particular messaging action in a most recent position of the chronological order of all inbound messages.

Clause 9. The method of any one of clauses 1-8, further comprising: refraining from outputting the notification of the particular messaging action in response to determining that the particular electronic message was deleted before the future time or that the particular messaging action was performed before the future time.

Clause 10. The method of any one of clauses 1-10, wherein modifying the particular electronic message to include the indication of the particular messaging action and the future time for outputting the notification of the particular messaging action comprises editing one or more fields of metadata of the particular electronic message to include the indication of the particular messaging action and the future time for outputting the notification of the particular messaging action.

Clause 11. The method of any one of clauses 1-10, wherein the plurality of initial criteria for invoking the model include: text associated with the particular electronic message that is indicative of a request directed specifically to at least one recipient of the particular electronic message; the text associated with the particular electronic message is indicative a specific deadline; a sender of the particular electronic message or the at least one recipient of the particular electronic message is a message account of a user that is likely to respond to the particular electronic message or receive a reply to the particular electronic message; and the text associated with the particular electronic message is indicative that some action is still needed.

Clause 12. The method of any one of clauses 1-11, further comprising: training, by the computing system, based on past user actions performed on other electronic messages, the model to identify the one or more subsequent messaging actions and future times for outputting notifications of the one or more subsequent messaging actions.

Clause 13. The method of any one of clauses 1-12, wherein the future time for outputting the notification of the particular messaging action includes a specific context that indicates one or more of a user activity, a user location, a specific day, and a time.

Clause 14. A computing system comprising: a model configured to automatically identify electronic messages that are likely to result in the computing system performing one or more subsequent messaging actions, wherein the one or more subsequent messaging actions include sending reply messages and sending follow-up messages; and at least one processor configured to: determine whether a particular electronic message satisfies at least one initial criteria from a plurality of initial criteria for invoking the model; responsive to determining that the particular electronic message satisfies the at least one initial criteria for invoking the model, determine, using the model, whether the particular electronic message is likely to result in the computing system performing a particular messaging action from the one or more subsequent messaging actions; and responsive to determining that the particular electronic message is likely to result in the computing system performing the particular messaging action: modify the particular electronic message to include an indication of the particular messaging action and a future time for outputting a notification of the particular messaging action; and output, at the future time, the notification of the particular messaging action.

Clause 15. A computing device comprising: a display; and at least one processor configured to: determine whether a particular electronic message satisfies at least one initial criteria from a plurality of initial criteria for invoking a model configured to automatically identify electronic messages that are likely to result in the computing device performing one or more subsequent messaging actions, wherein the one or more subsequent messaging actions include sending reply messages and sending follow-up messages; responsive to determining that the particular electronic message satisfies the at least one initial criteria for invoking the model, determine, using the model, whether the particular electronic message is likely to result in the computing device performing a particular messaging action from the one or more subsequent messaging actions; and responsive to determining that the particular electronic message is likely to result in the computing device performing the particular messaging action: modify the particular electronic message to include an indication of the particular messaging action and a future time for outputting a notification of the particular messaging action; and output, for display at the display and at the future time, a graphical indication of the notification of the particular messaging action.

Clause 16. The computing system of clause 14 or the computing device of clause 15, wherein the at least one processor of the computing system of clause 14 or the computing device of clause 15 is configured to perform any one of the methods of clauses 1-13.

Clause 17. A computer-readable storage medium comprising instructions that when executed, cause at least one processor to perform any one of the methods of clauses 1-13.

Clause 18. A system comprising means for performing any one of the methods of clauses 1-13.

Clause 19. A computer program comprising program instructions that, when executed on a computer, cause the computer to perform the method of any one of claims 1-13.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
determining, by a computing system, whether a particular electronic message satisfies at least one initial criteria from a plurality of initial criteria for invoking a model configured to automatically identify electronic messages that are likely to result in the computing system performing one or more subsequent messaging actions, wherein the one or more subsequent messaging actions include sending reply messages and sending follow-up messages;
responsive to determining that the particular electronic message satisfies the at least one initial criteria for invoking the model, determining, by the computing system, using the model, whether the particular electronic message is likely to result in the computing system performing a particular messaging action from the one or more subsequent messaging actions; and
responsive to determining that the particular electronic message is likely to result in the computing system performing the particular messaging action:
modifying the particular electronic message to include an indication of the particular messaging action and a future time for outputting a notification of the particular messaging action; and
outputting, at the future time, the notification of the particular messaging action.

2. The method of claim 1, wherein the particular electronic message is an outbound message, the method further comprising:
after modifying the outbound message to include the indication of the particular messaging action and the future time for outputting the notification of the particular messaging action, delivering the outbound message to an electronic mailbox of a user recipient of the outbound message.

3. The method of claim 1, wherein the particular electronic message is an inbound message, the method further comprising:
receiving the inbound message for delivery to an electronic mailbox of a user recipient of the inbound message;
after receiving the inbound message for delivery to one or more recipients of the outbound message, modifying the inbound message to include the indication of the particular messaging action and the future time for outputting the notification of the particular messaging action; and
delivering, the inbound message to an electronic mailbox of a user recipient of the inbound message.

4. The method of claim 1, further comprising:
after modifying the particular electronic message to include the indication of the particular messaging action and the future time for outputting the notification of the particular messaging action, storing, in an electronic mailbox of a sender of the electronic message or a recipient of the electronic message, a copy of the particular electronic message that includes the indication of the particular messaging action and the future time for outputting the notification of the particular messaging action.

5. The method of claim 1, wherein outputting the notification of the particular messaging action at the future time comprises presenting an indication the particular electronic message including an indication of the particular messaging action.

6. The method of claim 1, further comprising:
outputting, for display, a graphical user interface for managing electronic messages, wherein outputting the notification of the particular messaging action at the future time comprises displaying, more prominently than all other indications of electronic messages, an indication of the particular electronic message including an indication of the particular messaging action.

7. The method of claim 6, wherein:
the particular electronic message is an outbound message,
the graphical user interface is configured to display a most recently received inbound electronic message in a particular region of the graphical user interface, and
displaying the indication of the outbound message including the indication of the particular messaging action more prominently than all other indications of electronic messages comprises displaying the indication of the outbound message including the indication of the particular messaging action in the region of the graphical user interface at which the most recently received inbound electronic message was last displayed.

8. The method of claim 6, wherein:
the particular electronic message is an inbound message,
the graphical user interface is configured to display all inbound messages in chronological order, and
displaying the indication of the inbound message including the indication of the particular messaging action more prominently than all other indications of electronic messages comprises displaying the indication of the inbound message including the indication of the particular messaging action in a most recent position of the chronological order of all inbound messages.

9. The method of claim 1, further comprising:
refraining from outputting the notification of the particular messaging action in response to determining that the particular electronic message was deleted before the future time or that the particular messaging action was performed before the future time.

10. The method of claim 1, wherein modifying the particular electronic message to include the indication of the particular messaging action and the future time for outputting the notification of the particular messaging action comprises editing one or more fields of metadata of the particular electronic message to include the indication of the particular messaging action and the future time for outputting the notification of the particular messaging action.

11. The method of claim 1, wherein the plurality of initial criteria for invoking the model include:
text associated with the particular electronic message that is indicative of a request directed specifically to at least one recipient of the particular electronic message;
the text associated with the particular electronic message is indicative a specific deadline;
a sender of the particular electronic message or the at least one recipient of the particular electronic message is a message account of a user that is likely to respond to the particular electronic message or receive a reply to the particular electronic message; and
the text associated with the particular electronic message is indicative that some action is still needed.

12. The method of claim 1, further comprising:
training, based on past user actions performed on other electronic messages, the model to identify the one or more subsequent messaging actions and future times for outputting notifications of the one or more subsequent messaging actions.

13. The method of claim 1, wherein the future time for outputting the notification of the particular messaging action includes a specific context that indicates one or more of a user activity, a user location, a specific day, and a time.

14. A computing system comprising:
a model configured to automatically identify electronic messages that are likely to result in the computing system performing one or more subsequent messaging actions, wherein the one or more subsequent messaging actions include sending reply messages and sending follow-up messages; and
at least one processor configured to:
determine whether a particular electronic message satisfies at least one initial criteria from a plurality of initial criteria for invoking the model;
responsive to determining that the particular electronic message satisfies the at least one initial criteria for invoking the model, determine, using the model, whether the particular electronic message is likely to result in the computing system performing a particular messaging action from the one or more subsequent messaging actions; and
responsive to determining that the particular electronic message is likely to result in the computing system performing the particular messaging action:
modify the particular electronic message to include an indication of the particular messaging action and a future time for outputting a notification of the particular messaging action; and
output, at the future time, the notification of the particular messaging action.

15. The computing system of claim 14, wherein the particular electronic message is an outbound message, the at least one processor is further configured to:
after modifying the outbound message to include the indication of the particular messaging action and the future time for outputting the notification of the particular messaging action, deliver the outbound message to an electronic mailbox of a user recipient of the outbound message.

16. The computing system of claim 14, wherein the particular electronic message is an inbound message, the at least one processor is further configured to:
receive the inbound message for delivery to an electronic mailbox of a user recipient of the inbound message;
after receiving the inbound message for delivery to one or more recipients of the outbound message, modify the inbound message to include the indication of the particular messaging action and the future time for outputting the notification of the particular messaging action; and
deliver the inbound message to an electronic mailbox of a user recipient of the inbound message.

17. The computing system of claim 14, wherein the future time for outputting the notification of the particular messaging action includes a specific context that indicates one or more of a user activity, a user location, a specific day, and a time.

18. A computing device comprising:
a display; and
at least one processor configured to:
determine whether a particular electronic message satisfies at least one initial criteria from a plurality of initial criteria for invoking a model configured to automatically identify electronic messages that are likely to result in the computing device performing one or more subsequent messaging actions, wherein the one or more subsequent messaging actions include sending reply messages and sending follow-up messages;
responsive to determining that the particular electronic message satisfies the at least one initial criteria for invoking the model, determine, using the model, whether the particular electronic message is likely to result in the computing device performing a particular messaging action from the one or more subsequent messaging actions; and
responsive to determining that the particular electronic message is likely to result in the computing device performing the particular messaging action:
modify the particular electronic message to include an indication of the particular messaging action and a future time for outputting a notification of the particular messaging action; and
output, for display at the display and at the future time, a graphical indication of the notification of the particular messaging action.

19. The computing device of claim 18, wherein the particular electronic message is an outbound message, the at least one processor is further configured to:
after modifying the outbound message to include the indication of the particular messaging action and the future time for outputting the notification of the particular messaging action, deliver the outbound message to an electronic mailbox of a user recipient of the outbound message.

20. The computing device of claim 18, wherein the particular electronic message is an inbound message, the at least one processor is further configured to:
receive the inbound message for delivery to an electronic mailbox of a user recipient of the inbound message;
after receiving the inbound message for delivery to one or more recipients of the outbound message, modify the inbound message to include the indication of the particular messaging action and the future time for outputting the notification of the particular messaging action; and
deliver the inbound message to an electronic mailbox of a user recipient of the inbound message.
